(19) United States
(12) Patent Application Publication
(10) Pub. No.: US 2003/0082333 A1
(43) Pub. Date: May 1, 2003

(54) Sheet margin for feeding through nip rollers

(76) Inventors: Wayne Edward Evans, Lexington, KY (US); James Allen Lokovich, Georgetown, KY (US); John Stephen Mullins, Lexington, KY (US); Edward Allen Rush, Lexington, KY (US); William Reed Summers, Danville, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/512,009

(22) Filed: Feb. 24, 2000

(51) Int. Cl. B32B 3/02

(52) U.S. Cl. 428/81

(57) ABSTRACT

Sheets (3) have a narrow margin (3a) which are the first part of the sheet to enter nip rollers (5 and 7). This concentrates the pressure of the nip rollers on the narrow margin to assure a firm grip without slippage. Once the sheet is moving, continuing movement without slippage is assured from the momentum. This is particularly useful when the nip rollers are fixing rollers which are oiled to minimize toner transfer and when the sheet is a smooth transparency.

### TECHNICAL FIELD

This invention relates to the printing of sheets moved through nip rollers in an imaging device, such as a laser printer. Conventional sheets to be printed have straight margins, while this invention modifies the lead margin of sheets, such as paper and transparencies.

### BACKGROUND OF THE INVENTION

Sheets fed between nip rollers which rotate to move the sheet may slip or otherwise imperfectly follow the movement of the surface of the rollers. This is more of a problem for certain nip rollers which are exposed to oil or other potential lubricant. Nip fuser rollers often have some oil, such as silicone oil, applied for the purpose of minimizing adhesion of toner on the rollers.

No published document is known which addresses the tendency of a printed sheet to slip because of oil on nip rollers which feed the sheet. This invention remedies this tendency by having the lead margin entering the nip be reduced to a small area. U.S. Pat. No. 5,241,348 to Garavano et al. addresses a perceived wear problem by feeding rectangular sheets oriented so that a pointed comer of the sheets enters the nip first. Similarly, U.S. Pat. No. 5,452,062 to Baldwin et al. discloses feeding a tab stock through nip rollers with the small tab forward. U.S. Pat. No. 4,876,576 to Itaya et al. is illustrative of attempts to improve feeding by bowing the sheet so that its margin does not contact nip rollers simultaneously.

### DISCLOSURE OF THE INVENTION

In accordance with this invention, a side of a sheet to be fed, such as paper or a transparency, has a generally converging margin. The other sides of the sheet may form three sides of a rectangle, so that the body of the sheet conceptually contains a rectangle with at least one side of the rectangle having a pointed or narrow outward extension. Since the outward length of the extension is relatively short, the sheet is generally rectangular.

The narrow extension of the converging margin initially encounters the nip rollers and receives their full pressure, rather than having that pressure be distributed along the full width of the body of the sheet. This high pressure assures a firm contact and therefore reliable movement of the sheet. Since this gives the entire sheet movement, reliable continued movement of the entire sheet is realized.

This invention is particularly useful with smooth, unitary sheets having surfaces of low coefficient of friction, such as typical transparencies. Where the sheets have at least one margin which is straight, the sheets can be uniformly stacked by driving the straight margin against a straight reference surface.

### BRIEF DESCRIPTION OF THE DRAWINGS

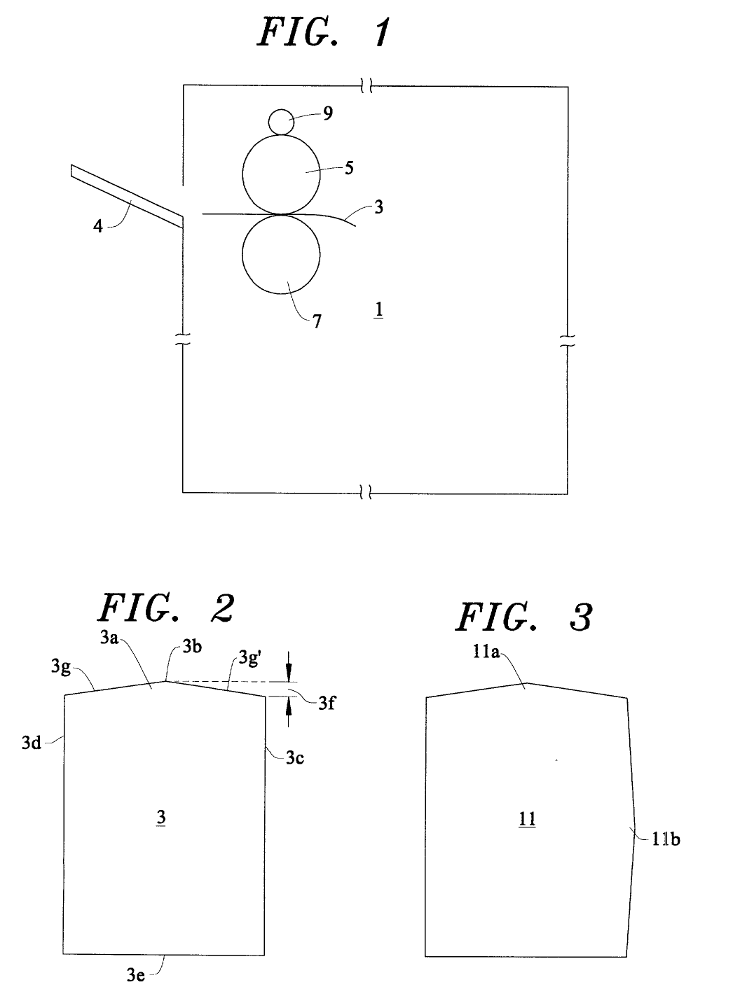

The details of this invention will be described in connection with the accompanying drawings, in which FIG. 1 is a largely illustrative side view of an imaging system having nip rollers for fixing; FIG. 2 is a plan view of a sheet having a side which tapers to a narrow end in accordance with this invention; and FIG. 3 is a plan view of a modification of the sheet of FIG. 2 for use when the length of the side to be fed is not known.

### DESCRIPTION OF THE PREFERRED EMBODIMENTS

FIG. 1 is illustrative of an imaging apparatus 1 such as a laser printer, having nip rollers for moving an imaging sheet 3. The details of imaging apparatus 1 are not shown as they may be entirely conventional, as widely employed in available laser printers or the imaging details may be novel, since this invention is not dependent upon the imaging implementation.

In laser printers loose toner in the form of an image is applied to the sheet 3, which is typically paper or a transparency, and then fused or melted onto the sheet 3, known as fixing. After fixing the sheet 3 is typically ejected to the outside of imaging apparatus 1, such as to a tray 4, where a human operator can take the sheet 3.

Fixing in this embodiment is by passing sheet 3 between nip roller 5 and 7 where the loose toner on sheet 3 is subject to heat and pressure. In the imaging device 1 the loose toner is on the upper side of sheet 3. Roller 5 is the upper roller and, as is conventional, roller 5 must be heated sufficiently to fix the toner. Roller 5 is driven by a motor (not shown) to advance sheet 3 by frictional contact between the surface of roller 5 and sheet 3. Lower roller 7, which may be termed the pressure roller, may be heated or not. At the top of heated roller 5, shown illustratively as roller 9, is an applicator that applies silicone oil to roller 5. Without the silicone oil, some toner from sheet 3 may transfer to roller 5 and then be transferred to subsequent sheets fed through imaging apparatus 1 to cause marring of the images on the subsequent sheets. Additionally, with certain toners, a sheet may stick to and thereby wrap around roller 5. Typical toner has low affinity for silicone oil and therefore tends to stay on sheet 3 when roller 5 has a coating of silicone oil. The foregoing fixing system of nip roller and oil applicator is widely known and may be entirely conventional or may be novel in the practice of this invention so long as it employs nip rollers to drive a sheet.

In use, however, the silicone oil may accumulate in the nip between roller 5 and 7. When sheet 3 reaches such a nip, the oil lowers the friction contact between roller 5 and sheet 3, and roller 5 may slip rather than drive sheet 3 as required. This is particularly true when sheet 3 is a transparency since transparencies are typically smooth plastic with a lower coefficient of friction than paper. Also, exceptionally thick transparencies are more difficult to feed.

To achieve reliable feeding of sheet 3 in accordance with this invention, at least the lead margin of sheet 3 is reduced to a narrow area. A preferred form is shown in FIG. 2. One margin 3a of the sheet 3 as shown in FIG. 2 extends outward slightly to form a central point 3b. In use the sheet 3 as fed by imaging apparatus 1 would be fed with the outwardly extending margin 3a as the leading margin. The sheet 3 has three straight margins 3c, 3d, and 3e. Margins 3c and 3d are opposite each other, are straight and are parallel to each other. Where these are the long margins as shown margins 3c and 3d are 11 inches long when letter size and 11.7 inches long for A4 size. Margin 3e is perpendicular to margins 3c and 3d. Where this is the narrow margin as shown, margin 3e is 8.5 inches long when letter size and 8.3 inches long for A4 size.

Margin 3a extends outward to point 3b a distance 3f of 1 to 2 millimeters from the imaginary line extending between the ends of margins 3c and 3d opposite margin 3e. Point 3b need not be sharp, as the end of point 3b need only constitute a narrow extension from the body of sheet 3 for the purposes of this invention. Sheet 3 may take other forms to practice this invention, but many imaging devices are built to accommodate sheets of generally letter or A4 size, so typically those would be the general size of sheet 3. However, when it is not known whether a sheet is to be fed narrow edge first or wide edge first, then one narrow edge and one wide edge will have the extension. Preferably only one margin will have an extension when then edge to be fed is known and only two margins will have an extension when the edge to be fed is not known. This leaves as many straight margins as possible for use in locating the sheets by driving the straight margins against a straight reference edge. FIG. 3 shows a sheet 11, generally of the size and configuration as sheet 3, but with two outwardly extending margins 11a and 11b, one long and one narrow, formed of converging sides as is margin 3a for use when it is not known whether a sheet is to be fed narrow edge first or wide edge first.

The preferred form of the extended margin, as shown in FIG. 2, has symmetrical, straight sides 3g and 3g′ converging to an intersection forming central point 3b. This places the narrow part of margin 3a in the center of sheet 3 to locate any resulting torque forces equally on opposite sides where they tend to cancel, thereby minimizing twist

In use the narrow, leading part of margin 3a, beginning with point 3b, enters the nip between roller 5 and roller 7. As is conventional, the rollers 5 and 7 are biased toward each other to assure significant pressure. All of this pressure is applied to the narrow leading part of margin 3a, which assures a tight grip between sheet 3 and roller 5. Sheet 3 is thereby reliably moved by roller 5 without slippage and this imparts momentum to sheet 3 so that continued movement with roller 5 is reliably assured.

It will be appreciated that the extended margin may take other forms, so long as the leading part is reduced. The reduced, leading part need not be continuous. Pointed extensions on opposite sizes would be expected to function well and to similarly reduce twist. In other systems twist might not be a problem and the reduced extension then would not need to be located to balance torque to reduce twist.

What is claimed is:

1. A sheet to receive images from an imaging apparatus of general size and general configuration of letter paper or A4 paper except that the margin of at least one side extends outward to form a generally converging extension.

2. The sheet as in claim 1 in which the margin of a least two sides of said sheet each extends outward to form a point generally converging extension.

3. The sheet as in claim 1 in which said margin of only one side extends outward to form a point generally converging extension.

4. The sheet as in claim 2 in which said margin of only two sides each extends outward to form a point generally converging extension.

5. The sheet as in claim 1 wherein the sheet is a smooth transparency.

6. The sheet as in claim 2 wherein the sheet is a smooth transparency.

7. The sheet as in claim 3 wherein the sheet is a smooth transparency.

8. The sheet as in claim 4 wherein the sheet is a smooth transparency.

9. The sheet as in claim 1 in which s aid generally converging extension is formed by generally symmetrical sides which converge at generally the center of the side having said point.

10. The sheet as in claim 2 in which each said generally converging extension is formed by generally symmetrical sides which converge at generally the center of the side having each said point.

11. The sheet as in claim 3 in which said generally converging extension is formed by generally symmetrical sides which converge at generally the center of the side having said point.

12. The sheet as in claim 4 in which each said generally converging extension is formed by generally symmetrical sides which converge at generally the center of the side having each said point.

13. The sheet as in claim 5 in which said generally converging extension is formed by generally symmetrical sides which converge at generally the center of the side having said point.

14. The sheet as in claim 6 in which each said generally converging extension is formed by generally symmetrical sides which converge at generally the center of the side having each said point.

15. The sheet as in claim 7 in which said generally converging extension is formed by generally symmetrical sides which converge at generally the center of the side having said point.

16. The sheet as in claim 8 in which each said generally converging extension is formed by generally symmetrical sides which converge at generally the center of the side having each said point.

17. A sheet to receive images from an imaging apparatus, said sheet being a smooth, unitary plastic, said sheet being generally rectangular and said sheet having at least one side which extends outward to form a margin, said margin being narrow relative to the length of said side from which said margin extends.

18. The sheet as in claim 17 in which at least two sides of said sheet each extends outward to form a margin, each said margin being narrow relative to the length of said side from which each said margin extends.

19. The sheet as in claim 17 in which said margin of only one side extends outward to form said margin narrow relative to the length of said only one side.

20. The sheet as in claim 18 in which said margin of only two sides extends outward to from said margin narrow relative the length of said side from which each said margin extends.

21. Imaging apparatus having nip rollers for advancing and fixing imaged sheets under heat and pressure, said nip rollers having oil applied to at least one of said nip rollers, said imaging apparatus moving a sheet with a loose toner image to said nip rollers to fix said image, said sheet being a sheet as described in claim 1 with said point being the first part of said sheet to reach said nip rollers.

22. Imaging apparatus having nip rollers for advancing and fixing imaged sheets under heat and pressure, said nip roller having oil applied to at least one of said nip rollers, said imaging apparatus pass a sheet with a loose toner image to said nip rollers to fix said image, said sheet being a sheet as described in claim 17 with said margin narrow relative to the length of said side from which said margin extends being the first part of said sheet to reach said nip rollers.
